(19) United States
(12) Patent Application Publication
(10) Pub. No.: US 2008/0135426 A1
(43) Pub. Date: Jun. 12, 2008

(54) Dispensing Apparatus Component System

(75) Inventors: Thomas R. Hecht, Winters, CA (US); Juha K. Salmela, Citrus Heights, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Automatic Bar Controls, Inc., Vacaville, CA (US)

(21) Appl. No.: 11/947,688

(22) Filed: Nov. 29, 2007

Related U.S. Application Data
(60) Provisional application No. 60/861,842, filed on Nov. 29, 2006.

(51) Int. Cl. B65D 69/00; B23P 19/04

(52) U.S. Cl. 206/223; 29/700

(57) ABSTRACT

A component system kit for assembling a dispensing apparatus is disclosed. The kit includes one or more inlet fittings, the inlet fittings configured to deliver a fluid from a fluid source; a pump body configured to connect with the one or more inlet fittings; an outlet elbow configured to connect with the pump body; and one or more outlet fittings configured to connect with the outlet elbow.

### CROSS-REFERENCES TO RELATED APPLICATIONS

This application claims priority to U.S. Provisional Patent Application No. 60/861,942, filed Nov. 29, 2006 whose teachings are incorporated herein by reference.

### BACKGROUND OF THE INVENTION

The present invention is generally related to dispensing systems, and more particularly to a component system for a dispensing apparatus. The component system provides for fluid communication with the dispensing apparatus via one or more inlet fittings, a pump body, one or more outlet fitting and an optional base.

It is often desirable to dispense a condiment, a beverage, or the like by consistent amounts. Both mechanical and electronic devices have been used to control the portion dispensed with varying degrees of success. Some of the devices are rather complex and expensive. Some may be difficult to clean and maintain.

One such dispensing apparatus is disclosed in the assignee's issued U.S. Pat. No. 6,405,897, entitled: “Hand-Operated Syringe Pumping System.” Such a pump may be used to dispense different fluids, such as condiments, beverages, or the like. Currently, such condiment pumps are designed for specific applications and for fitting within specific external design constraints (e.g., cabinets, covers, and the like). For each particular application, individual components, such as inlet fittings, pump body and outlet fittings, are machined from solid stock or molded and then bonded or otherwise fastened together into the finished pump assembly. With the currently available system design modifications, finished pump assemblies cannot be readily adapted, modified or reconfigured.

There is therefore a need for a component system for a dispensing apparatus that can be readily adapted for varying dispensing apparatus applications.

### BRIEF SUMMARY OF THE INVENTION

The present invention is directed toward a component system for a dispensing apparatus that can be readily adapted for varying dispensing apparatus applications. In one aspect, the present invention provides a component system kit for assembling a dispensing apparatus, including one or more inlet fittings, the inlet fittings configured to deliver a fluid from a fluid source; a pump body configured to connect with the one or more inlet fittings; an outlet elbow configured to connect with the pump body; and one or more outlet fittings configured to connect with the outlet elbow. The one or more outlet fittings may be configured to connect with other dispensing system outlet fittings or components.

In one embodiment, the invention provides a component system kit for assembling a dispensing apparatus. The kit includes at least one inlet fitting, each of the at least one inlet fitting having a fluid inlet and a fluid outlet, the fluid inlet portion of the inlet fitting being configured to receive a conduit for a fluid from a fluid source; a pump body having a pump fluid inlet and a pump fluid outlet, the pump body fluid inlet and each of the fluid outlets of the inlet fittings being configured to connect the pump fluid inlet with each of the fluid outlets of the one or more inlet fittings; an outlet elbow having an elbow inlet and an elbow outlet, the outlet elbow inlet being configured to connect with the pump fluid outlet; and at least one outlet fitting, each of the at least one outlet fitting having a fluid inlet and a fluid outlet, each of the fluid inlets of the outlet fittings being configured to connect with the elbow outlet.

The kit may also include a base configured to support the pump body and the outlet elbow. The pump body may include surface projections configured to rest against a top surface of the base. The outlet elbow may also include surface projections configured to rest against a top surface of the base.

In one aspect, at least one of the one or more inlet fittings can include a valve. The valve may be a check valve or specifically a ball check valve.

In another aspect, the outlet elbow can include a valve. The valve may be a check valve or specifically a ball check valve.

In another aspect, a raised ring-shaped surface projection extending from the fluid outlet of each of the at least one inlet fittings is dimensioned to fit inside and against an internal surface of the pump fluid inlet. The at least one inlet fitting is dimensioned to fit inside and against an internal surface of the pump fluid inlet via a compression fit.

In another aspect, one of the inlet fittings may be solvent bonded or ultrasonically bonded with the pump inlet.

In another aspect, the elbow inlet of the outlet elbow is dimensioned to fit inside and against an internal surface of the pump fluid outlet. One of the elbow inlet of the outlet elbow and the pump fluid outlet may include a key and the other of the elbow inlet of the outlet elbow and the pump fluid outlet may include a slot shaped to engage the key. The elbow inlet of the outlet elbow is dimensioned to fit inside and against an internal surface of the pump fluid outlet via a compression fit. The elbow inlet of the outlet elbow may be solvent bonded or ultrasonically bonded with the pump fluid outlet.

In another aspect, the fluid inlet of each of the at least one outlet fittings is dimensioned to fit over and against an external surface of the outlet elbow outlet. The fluid inlets of each of the at least one outlet fittings are dimensioned to fit over and against an external surface of the outlet elbow outlet via a compression fit. One of the outlet fittings may be solvent bonded or ultrasonically bonded with the outlet elbow.

In another aspect, at least one of the inlet fitting fluid inlets may include a quick connect fitting so as to receive a fluid conduit therein.

In another aspect, at least one of the outlet fitting fluid outlets may include a quick connect fitting so as to receive a fluid conduit therein.

In another embodiment, the present invention provides a method of forming a portion of a dispensing apparatus. The method includes providing the kit described above, connecting the fluid outlet of one of the inlet fittings with the fluid inlet of the pump; connecting the fluid inlet of the outlet elbow with the fluid outlet of the pump; and connecting the fluid inlet of one of the outlet fittings with the elbow outlet. The connecting may include solvent bonding or an ultrasonic bonding.

For a further understanding of the nature and advantages of the invention, reference should be made to the following description taken in conjunction with the accompanying drawings.

### BRIEF DESCRIPTION OF THE DRAWINGS

FIG. 1 is a perspective view of a known dispensing system that can be modified by using the dispensing apparatus component system kit constructed in accordance with the embodiments of the present invention.

FIG. 2 is an exploded perspective view of the dispensing system of FIG. 1.

FIG. 3 is a cross-sectional view of the dispensing system of FIG. 1.

FIG. 4 is a cross-sectional view of another dispensing system that can be modified by using the dispensing apparatus component system kit constructed in accordance with the embodiments of the present invention.

FIG. 5 is a simplified drawing of the component system or kit having a suite of interconnecting parts designed for easy assembly into various configurations for a dispensing apparatus in accordance with the embodiments of the present invention.

FIG. 6 is a simplified drawing of one embodiment of an assembly using the kit parts of FIG. 5 above.

FIG. 7 is a simplified drawing of an alternative embodiment of an assembly using the kit parts of FIG. 5 above.

FIG. 8 is a cross-sectional view of the assembled dispensing apparatus component system of FIG. 7.

FIG. 9 is a simplified drawing of another alternative embodiment of an assembly using the kit parts of FIG. 5 above.

FIG. 10 is a simplified drawing of another alternative embodiment of an assembly using the kit parts of FIG. 5 above.

FIG. 11 is a cross-sectional view of the assembled dispensing apparatus using the component system of FIG. 10.

### DETAILED DESCRIPTION OF THE INVENTION

The present invention is directed toward a dispensing system component system or kit having a suite of interconnecting parts designed for easy assembly into various configurations or assemblies for a dispensing apparatus. The present kit greatly improves the efficiency, and reduces complexity of specific and separate machined parts for each separate and/or specific application of a dispensing system. The dispensing system can be a condiment pump, such as the one described in U.S. Pat. No. 6,405,897, entitled: “Hand-Operated Syringe Pumping System,” the disclosure of which is hereby incorporated by reference herein. The dispensing apparatus disclosed in the '897 patent is briefly described below. Such a system includes a pump body, an inlet valve housing, a pump chamber and an outlet valve housing. When assembled together with the dispensing apparatus, the inlet valve housing is connected with a delivery tube; and the outlet valve housing is connected with an outlet spout. The kit in accordance with the embodiments of the present invention can be used with the pumping system disclosed in the '897 patent, as well as other and similar pumps.

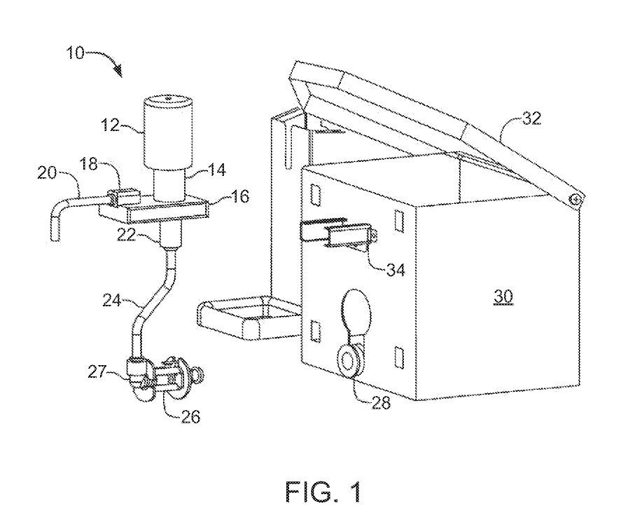

FIGS. 1-3 show a dispensing apparatus 10 that can be modified by using the component system constructed in accordance with the embodiments of the present invention. The apparatus 10 includes a plunger housing 12 movably coupled with a pump chamber 14 supported on a pump body 16. An outlet valve housing 18 is coupled between the pump body 16 and an outlet spout 20. An inlet valve housing 22 is coupled between the pump body 16 and a delivery tube 24, which is coupled with a connector 26 by a fitting 27. The connector 26 is detachably coupled to a spout or outlet 28 of a fluid source such as a Bag-in-Box (BIB) disposed in the box 30. The box 30 has a lid 32 for installing and removing the BIB. A pump mounting bracket 34 is provided on the side of the box 30 for mounting the pump body 16.

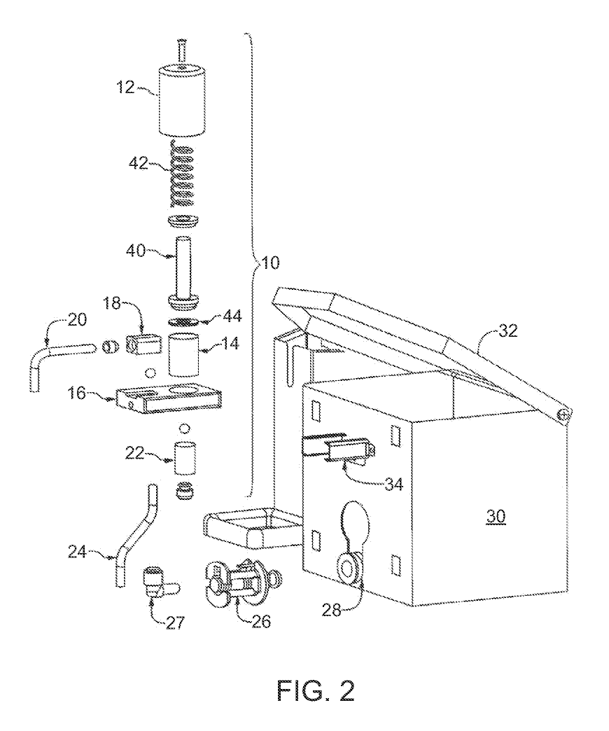

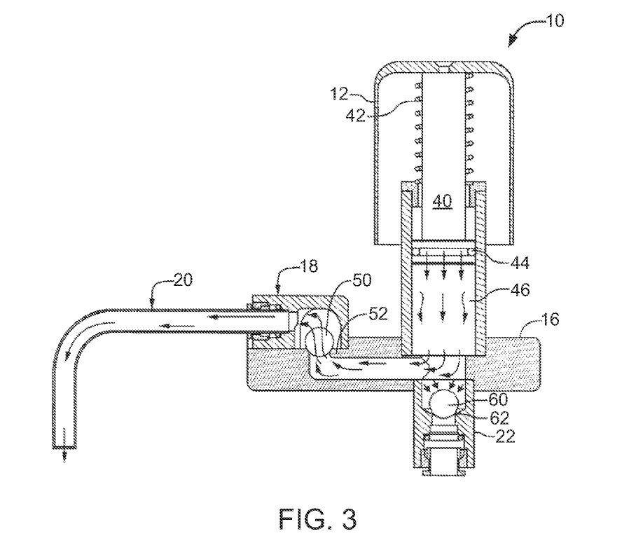

As best seen in FIGS. 2 and 3, a plunger 40 is movable inside the pump chamber 14 and is connected to the plunger housing 12. A spring 42 is connected between the plunger 40 and the chamber 14 to bias the plunger 40 upward to expand the cavity 46 of the chamber 14. A seal 44 is provided between the plunger 40 and the interior wall of the chamber 14 to seal the chamber cavity 46.

An outlet ball 50 is disposed at an outlet opening 52 of the outlet valve housing 18 in a closed position, and is movable upward by a sufficient pressure to permit fluid flow in an open position. An inlet ball 60 is disposed at an inlet opening 62 of the inlet valve housing 22, and is movable upward by a sufficient pressure to permit fluid flow in an open position. In the embodiment shown, the inlet and outlet balls 50, 60 are biased toward the closed positions by gravity. In an alternate embodiment, springs or other biasing members may be used. Further details of the operation of the pump apparatus 10 are provided in the '897 patent.

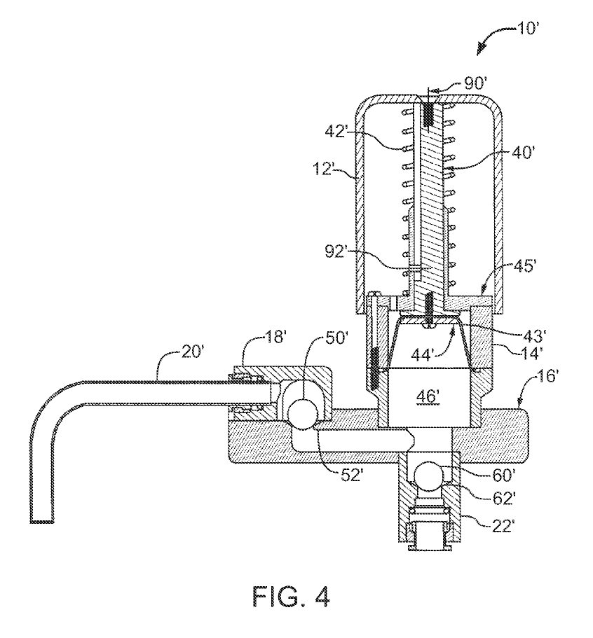

FIG. 4 shows another dispensing system that can be modified by using the dispensing apparatus component system constructed in accordance with the embodiments of the present invention. FIG. 4 shows the dispensing system 10′ which is similar to the apparatus 10 of FIGS. 1-3. Instead of the piston at the end of the plunger 40, the apparatus 10′ in FIG. 4 includes a flexible member serving as a rolling diaphragm piston 43′ for changing the volume of the chamber cavity 46′ and for opening and closing the inlet and outlet check valves by moving the inlet and outlet balls 50′, 60′. The diaphragm 43′ is attached along the side wall of the chamber 14′ and extends over the cross-section of the cavity 46′ of the chamber 14′. The diaphragm 43′ is attached to the plunger 40′ by a diaphragm retainer 44′ to move with the plunger 40′. The plunger 40′ is guided by a plunger guide 45′ and resiliently biased by the spring 42′ upward to expand the chamber cavity 46′. The use of the diaphragm 43′ eliminates sliding of a piston over the side wall of the chamber 14′ and the need for a sliding seal. The diaphragm 43′ is typically made of a flexible elastomer such as silicone and desirably has good strength properties and is compatible with food products such as beverages and condiments. Example of a suitable material is EPDM.

As shown in FIG. 4, a fastener 90′ couples the plunger housing 12′ to the plunger 40′, and desirably permits rotation of the housing 12′ relative to the plunger 40′ around it axis. An anti-rotation pin 92′ connects the plunger 40′ to the plunger guide 45′. Of course, other ways of configuring the components of the apparatus and which are known to those skilled in the art may be used.

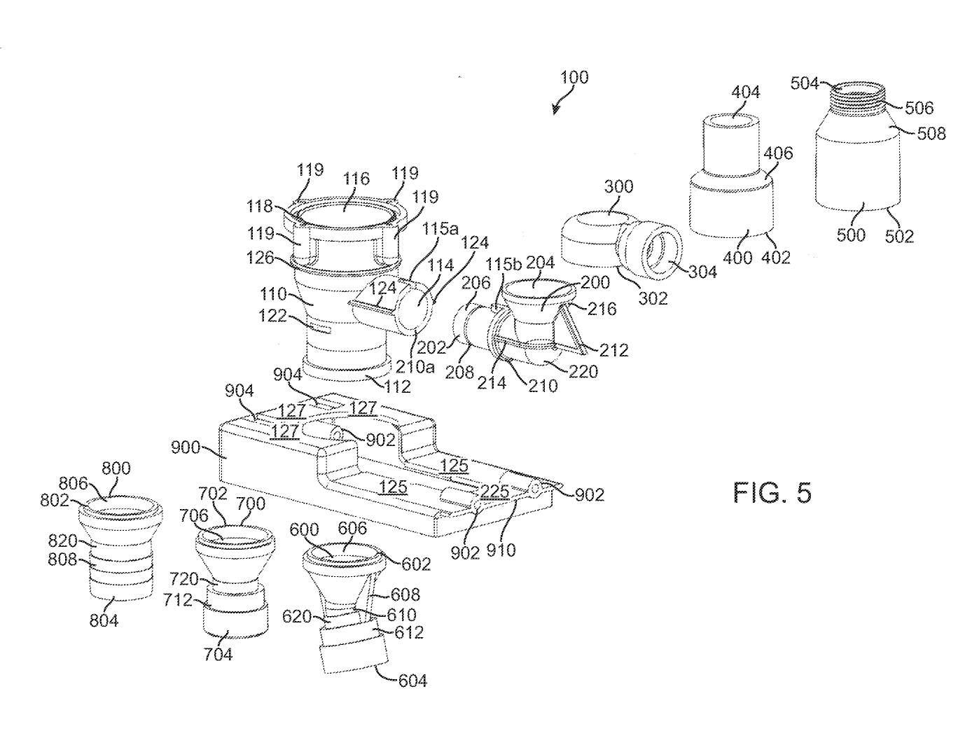

The dispensing systems described above in FIGS. 1-4 can be modified by using the component systems described below and shown in FIGS. 5-11.

FIG. 5 is a simplified drawing illustrating the component system 100 or kit having a suite of interconnecting parts designed for easy assembly into various configurations for a dispensing apparatus, in accordance with the embodiments of the present invention. FIG. 5 shows that the kit can include a base piece 900, a pump body 110, an outlet elbow 200, a set of inlet fittings 600, 700, 800, and a set of outlet fittings 300, 400, and 500. The parts of the kit shown can be produced by a molding process using a plastic material. The plastic material is preferably made from FDA food contact approved resins. One example of a preferred plastic materials includes high impact polystyrene, although other suitable materials known to those skilled in the art may be used. It is preferred that the same material be used to construct the kit parts. In this manner the kit parts are matched so as to have the same shrinkage and expansion characteristics, so that when the parts are coupled or connected with one another stresses due to differing expansions or contractions between the parts are minimized. The kit parts when connected with one another to form a part of a dispensing apparatus may be coupled with one another by a friction fit, a compression fit, or a snap fit.

When fitted together the kit parts may also be bonded to one another. The kit parts may be bonded to one another by a solvent bonding process. As used herein, solvent bonding or solvent welding refers to a process in which the surfaces of parts to be joined are treated with a solvent. This swells and softens the surfaces and by applying pressure to the joint and with the evaporation of the solvent, the two surfaces bond. Adhesives are not typically used in a solvent bonding process. Advantages of solvent bonding include a homogeneous distribution of mechanical loads; good aesthetics; economic assembly; low weight joints by avoiding the use of heavy screws, bolts and nuts. With the solvent bonding process, heat sensitive constructions or materials, which welding would distort or destroy, can be joined. Solvent bonding also enables good sealing and insulating properties. The kit parts may also be joined with one another by an ultrasonic welding process. As used herein, ultrasonic welding refers to an industrial technique whereby high-frequency ultrasonic acoustic vibrations are used to weld objects together, usually plastics materials. This type of welding may be used to build assemblies that are too small, too complex, or too delicate for more common welding techniques. In ultrasonic welding, there are no connective bolts, nails, soldering materials, or adhesives necessary to bind the materials together. The kit parts may also be joined with one another using adhesives.

The parts of the kit can be combined without further modifications into any one of several (e.g., at least 36) assembly configurations. This in turn makes it easier to accommodate various design restrictions and/or desires. The suite of dispensing assemblies that can be assembled from the kit of the present invention enables the efficient replacement of a pump assembly for pumps manufactured by the assignee herein or any other suitable pumps with a minimal amount of visible or external modification of the end product. Each of its sub parts, 110, 200, 300, 400, 500, 600, 700, 800 and 900 have various unique and specific advantageous features, each of which is described below.

The pump body 110 includes a fluid inlet 112 and a fluid outlet 114. The fluid entering the pump body at 112 gets pressurized by either a piston or a diaphragm assembly, such as those described above, that connects with the pump body at the pump body's upper boundary 118. Mounting bosses 119 are used to allow for the pump body 110 to connect with a pressurization assembly. The fluid entering the pump body 110 at inlet 112 can make a 90 Deg. bend before it exits the pump body 110 at the outlet 114. The fluid inlet 112 is ring-shaped and is dimensioned to receive the outlet side of either of the inlet fittings 600, 700 or 800. Raised surfaces 602, 702, or 802 are dimensioned to fit inside the fluid inlet 112 of the pump body. The fit may be a compression fit, a snap fit or a friction fit. The pump body 110 is shown to have a diverging section in the direction of fluid flow. The divergent section helps with the pressurization of the fluid and the transition in the fluid flow area from the pump body inlet 112 towards the pump body outlet 112.

The pump body 110 can also include an anti-rotation surface 122. The anti-rotation surface 122 may be a recess or a projection. The anti-rotation surface 122 may be used to prevent the rotation of the pump body 110 about its vertical longitudinal axis when the pump body 110 is placed in or surrounded by a housing that engages the anti-rotation surface 122. The fluid outlet 114 may also include projections 124. Projections 124 can provide for additional structural strength, a grasping surface or both. In addition, the projections 124 can also serve as a bonding surface for the bonding of the pump body 110 with the base piece 900, for example at surface 125. In addition, the pump body 110 also includes a projection surface 126. The projections 126 can provide for additional structural strength, a grasping surface or both. In addition, the projections 126 can also serve as a bonding surface for the bonding of the pump body 110 with the base piece 900, for example at surface 127. The pump body 110 also includes an engagement surface 115a that is dimensioned to engage a complementarily-shaped engagement surface 115b on the outlet elbow. The engagement surfaces 115a, 115b enable a more secure connection between the pump body 110 and the outlet elbow 200. The engagement surfaces 115a, 115b also prevent the rotation of the outlet elbow 200 relative to outlet 114 of the pump body 110. As is shown in FIG. 5, engagement surfaces 115a, 115b, include a slot 115a, and a key 115b. It should be realized that other engagement surfaces may be used. For example, the key could be placed on the outlet portion 114 of the pump body 110 and the slot could be places on the outlet elbow 200. The key and the slot arrangement can have any shape, and multiple key and slot arrangements may be used. The multiple keys and slots could be arranged around the circumference of the outlet portion 114 of the pump body and the outlet elbow 200.

The outlet elbow 200 has a fluid inlet 202 and a fluid outlet 204. The outlet elbow 200 connects at its inlet 202 with the pump body outlet 114 as described above. Preferably, the inlet portion of the outlet elbow slides into the outlet portion 124 of the pump body 110. The inlet portion of the outlet elbow may include a portion 206. Portion 206 is shown to extend away from the outlet elbow at ring 208. Ring 208 may include a scored surface to facilitate the removal of portion 206 from the outlet elbow 200. The outlet elbow 200 is inserted into the outlet portion of the pump 124 until engagement surfaces 115a and 115b engage one another to prevent the further insertion of the outlet elbow 200 into the pump outlet 114. The outlet elbow may also include the surface 210. The surface 210 may be used to provide for additional structural strength for the outlet elbow 200. The surface 210 may also be used as a bonding surface for connecting the elbow 200 with the pump body 110. Surface 210 may also be used to limit the extent of the insertion of the outlet elbow into the pump body. Surface 210 is shown to extend about the circumference of the inlet portion of the outlet elbow 110. It should be realized that surface 210 may have any shape that is suitable for abutting against the front face 210a of the pump body. For example, the surface 210 need not extend about the entire circumference of the inlet portion 202 of the outlet elbow 200. The outlet elbow 200 may also include a surface 214. Surface projections 214 can provide for additional structural strength, a grasping surface or both. In addition, the projections 214 can also serve as a bonding surface for the bonding of the outlet elbow 200 with the base piece 900, for example at surface 125. Surface projection 214 may extend along a horizontal dimension so that it is at the same elevation as surface 124 of the pump body 100. In addition, the outlet elbow 200 may also include a projection surface 212. The projection surface 212 can provide for additional structural strength, a grasping surface or both. In addition, the projection surface 212 can also serve as a bonding surface for the bonding of the outlet elbow 200 with the base piece 900, for example at surface 225. The outlet elbow may also include a check valve 220. The check valve 220 may be an outlet ball check valve, which can function as described above.

The outlet side 204 of the outlet elbow 200 is dimensioned to be coupled with the inlet side of either of the outlet fittings 300, 400 or 500. As can be seen from FIG. 5, the outlet fittings 300, 400 or 500 can have differing geometries resulting in different flow geometries for the fluid that is being dispensed. It should be realized that the outlet fittings shown in FIG. 5 are exemplary outlet fittings and that an outlet fitting constructed in accordance with the principles of the invention may include one or more of the features of the fittings shown in FIG. 5.

One exemplary outlet fitting 300 includes a fluid inlet portion 302 and a fluid outlet portion 304. The inlet portion 302 is dimensioned so as to fit over the outlet portion 204 of the outlet elbow. The inlet portion 302 once coupled with the outlet portion 204 of the outlet elbow 200 can be rotated relative to the outlet portion 204. The inlet portion 302 can be bonded together with the outlet elbow 200 as described above at any position relative to the outlet elbow 200. The fluid entering the outlet fitting 300 undergoes a change on direction and flow area as it is directed toward the outlet 304. For the outlet fitting 300, the outlet portion 304 is shown to project away from a side of the main body of the outlet fitting 300, to create a flow path at the inlet 302 that is generally perpendicular to the flow path at the outlet 304. The outlet 304 is configured to receive a plastic tubing. Such a tubing may be placed over the outlet 304 or it may be placed inside the outlet 304. A variety of structures may be used to create joints with plastic tubing. In on specific embodiment, the outlet 304 is dimensioned to receive mechanical couplings providing temporary connections with an outlet tubing. Examples of these types of mechanical connections include the use of ferrules with a crimp process, push-style fittings such as those manufactured by John Guest International Ltd. and threaded style compression fittings such as those manufactured by JACO Manufacturing Company. The push-style fittings such as the John Guest International fittings (e.g. push in quick connect fittings) are preferred since when using such a push in quick connect fitting, to make a connection, a tube is simply pushed in by hand. The push style fitting which may have a locking system then holds the tube firmly in place without deforming it or restricting flow. As is shown in FIG. 5, the outlet portion 304 narrows down before it joins with the main body of the fitting 300. This change in the external area of the outlet portion 304 may be made to accommodate the wall thickness requirements for the outlet portion 304, especially when the outlet portion 304 is dimensioned to receive a push-style fittings such as those manufactured by John Guest International Ltd. For example, a minimum or desired wall thickness is maintained for the outlet portion 304 of the outlet fitting 300 to accommodate the change in the internal passageway of the outlet portion 304 of the outlet fitting 300 made to receive a specific type of push-style fittings.

FIG. 5 also shows another exemplary outlet fitting 400, which includes a fluid inlet portion 402 and a fluid outlet portion 404. The inlet portion 402 is dimensioned so as to fit over the outlet portion 204 of the outlet elbow. The inlet portion 402 once coupled with the outlet portion 204 of the outlet elbow 200 can be rotated relative to the outlet portion 204. The inlet portion 402 can be bonded together with the outlet elbow 200 as described above at any position relative to the outlet elbow 200. The fluid entering the outlet fitting 400 undergoes a change in flow area as it is directed toward the outlet 404. For the outlet fitting 400, the outlet portion 404 is shown to have a flow area that is aligned and is coaxial with respect to the inlet 402. The outlet 404 is configured to receive a plastic tubing. Such a tubing may be placed over the outlet 404 or it may be placed inside the outlet 404. A variety of structures may be used to create joints with plastic tubing. In on specific embodiment, the outlet 404 is dimensioned to receive a mechanical couplings providing temporary connections with an outlet tubing. Examples of these types of mechanical connections include the use of ferrules with a crimp process, push-style fittings such as those manufactured by John Guest International Ltd. and threaded style compression fittings such as those manufactured by JACO Manufacturing Company. The push-style fittings such as the John Guest International fittings (e.g. push in quick connect fittings) are preferred since when using such a push in quick connect fitting, to make a connection, a tube is simply pushed in by hand. The push style fitting which may have a locking system then holds the tube firmly in place without deforming it or restricting flow. As is shown in FIG. 5, the outlet fitting 400 narrows down from its inlet 402 towards its outlet 404. This change in the area 406 of the outlet fitting 400 may be a gradual or an abrupt change and which may be made to provide a transition from the flow area at the inlet 402 to that at the outlet 404.

FIG. 5 also shows another exemplary outlet fitting 500, which includes a fluid inlet portion 502 and a fluid outlet portion 504. The inlet portion 502 is dimensioned so as to fit over the outlet portion 204 of the outlet elbow. The inlet portion 502 once coupled with the outlet portion 204 of the outlet elbow 200 can be rotated relative to the outlet portion 204. The inlet portion 502 can be bonded together with the outlet elbow 200 as described above at any position relative to the outlet elbow 200. The fluid entering the outlet fitting 500 undergoes a change in flow area as it is directed toward the outlet 504. For the outlet fitting 500, the outlet portion 504 is shown to have a flow area that is aligned and is coaxial with respect to the inlet 502. The outlet 504 is configured to receive a plastic tubing. Such a tubing may be placed over the outlet 404 or it may be placed inside the outlet 404. The outlet fitting 500 may also include a threaded portion 506. The threaded portion is used to receive a nut to securely hold an outlet tubing or spout that is inserted into the outlet portion 504 of the outlet fitting 500. Alternatively, the outlet fitting may have a push-in type coupling on the outlet portion 504 such as those described above for the outlet fittings 300 and 400. As is shown in FIG. 5, the outlet fitting 500 narrows down from its inlet 502 towards its outlet 504. This change in the area 508 of the outlet fitting 500 may be a gradual or an abrupt change and which may be made to provide a transition from the flow area at the inlet 502 to that at the outlet 504.

Also shown in FIG. 5 are the inlet fittings 600, 700 and 800. As can be seen from FIG. 5, the inlet fittings 600, 700 or 800 can have differing geometries resulting in different flow geometries for the fluid that is being dispensed. It should be realized that the inlet fittings shown in FIG. 5 are exemplary inlet fittings and that an inlet fitting constructed in accordance with the principles of the invention may include one or more of the features of the fittings shown in FIG. 5.

One exemplary inlet fitting 600 includes a fluid inlet portion 604 and a fluid outlet portion 606. The raised surface 602 is dimensioned to fit inside the fluid inlet 112 of the pump body 110. It should be realized that the outlet portion 606 may fit over and around the fluid inlet 112 of the pump body 110. The outlet portion 602 once coupled with the fluid inlet 112 of the pump body 110 can be rotated relative to the fluid inlet 112 of the pump body 110. The outlet portion 606 and raised surface 602 can be bonded with fluid inlet 112 of the pump body 110 as described above at any position relative to the fluid inlet 112 of the pump body 110. The fluid entering the inlet fitting 600 undergoes a change on direction 610 of the flow as it is directed toward the outlet 606. For the inlet fitting 600 the outlet portion 606 is shown to be angled slightly away from the inlet portion 606 thus imparting a bend in the flow from the inlet 604 toward the outlet 606. The inlet 604 is configured to receive a plastic tubing. Such a tubing may be placed over the inlet 604 or it may be placed inside the inlet 604. A variety of structures may be used to create joints with plastic tubing. In on specific embodiment, the inlet 604 is dimensioned to receive a mechanical couplings providing temporary connections with an outlet tubing. Examples of these types of mechanical connections include the use of ferrules with a crimp process, push-style fittings such as those manufactured by John Guest International Ltd. and threaded style compression fittings such as those manufactured by JACO Manufacturing Company. The push-style fittings such as the John Guest International fittings (e.g. push in quick connect fittings) are preferred since when using such a push in quick connect fitting, to make a connection, a tube is simply pushed in by hand. The push style fitting which may have a locking system then holds the tube firmly in place without deforming it or restricting flow. As is shown in FIG. 5, the inlet side 612 of the inlet fitting 600 narrows down before the bend. This change in the external area of the inlet side 612 may be made to accommodate the wall thickness requirements for the inlet side 612, especially when the inlet side 612 is dimensioned to receive a push-style fittings such as those manufactured by John Guest International Ltd. For example, a minimum or desired wall thickness is maintained for the inlet side 612 of the inlet fitting 600 to accommodate the change in the internal passageway of the inlet side 612 of the inlet fitting 600 made to receive a specific type of push-style fittings. The inlet fitting 600 may also include a check valve 620. The check valve 620 may be an inlet ball check valve, which can function as described above. The inlet fitting 600 may also include support structures 608 that project away from the fitting 600 so as to provide structural support for the piece and/or to enhance its moldability. The inlet fitting 600 is shown to include an external shape that has a converging then diverging profile. The inlet and outlet geometries are dimensioned to receive a tubing and to couple with the pump body 110, respectively. The remainder of the geometry is dimensioned to provide for an efficient transition from the inlet geometry to the outlet geometry for the inlet fitting.

FIG. 5 also shows another exemplary inlet fitting 700, which includes a fluid inlet portion 704 and a fluid outlet portion 706. The inlet fitting 700 is similar to the inlet fitting 600 with the exception that it has as a straight through geometry without the bend 610. The raised surface 702 is dimensioned to fit inside the fluid inlet 112 of the pump body 110. It should be realized that the outlet portion 706 may fit over and around the fluid inlet 112 of the pump body 110. The outlet portion 706 once coupled with the fluid inlet 112 of the pump body 110 can be rotated relative to the fluid inlet 112 of the pump body 110. The outlet portion 706 and raised surface 702 can be bonded with fluid inlet 112 of the pump body 110 as described above at any position relative to the fluid inlet 112 of the pump body 110. The inlet 704 is configured to receive a plastic tubing. Such a tubing may be placed over the inlet 704 or it may be placed inside the inlet 704. A variety of structures may be used to create joints with plastic tubing. In one specific embodiment, the inlet 704 is dimensioned to receive a mechanical couplings providing temporary connections with an outlet tubing. Examples of these types of mechanical connections include the use of ferrules with a crimp process, push-style fittings such as those manufactured by John Guest International Ltd. and threaded style compression fittings such as those manufactured by JACO Manufacturing Company. The push-style fittings such as the John Guest International fittings (e.g. push in quick connect fittings) are preferred since when using such a push in quick connect fitting, to make a connection, a tube is simply pushed in by hand. The push style fitting which may have a locking system then holds the tube firmly in place without deforming it or restricting flow. As is shown in FIG. 5, the inlet side 712 of the inlet fitting 700 narrows down before the bend. This change in the external area of the inlet side 712 may be made to accommodate the wall thickness requirements for the inlet side 712, especially when the inlet side 712 is dimensioned to receive a push-style fittings such as those manufactured by John Guest International Ltd. For example, a minimum or desired wall thickness is maintained for the inlet side 712 of the inlet fitting 700 to accommodate the change in the internal passageway of the inlet side 712 of the inlet fitting 700 made to receive a specific type of push-style fittings. The inlet fitting 700 may also include a check valve 720. The check valve 720 may be an inlet ball check valve, which can function as described above. The inlet fitting 700 is shown to include an external shape that has a converging then diverging profile. The inlet and outlet geometries are dimensioned to receive a tubing and to couple with the pump body 110, respectively. The remainder of the geometry is dimensioned to provide for an efficient transition from the inlet geometry to the outlet geometry for the inlet fitting.

FIG. 5 also shows another exemplary inlet fitting 800, which includes a fluid inlet portion 804 and a fluid outlet portion 806. The inlet fitting 800 is similar to the inlet fitting 700 in that it has as a straight through geometry. The raised surface 802 is dimensioned to fit inside the fluid inlet 112 of the pump body 110. It should be realized that the outlet portion 806 could fit over and around the fluid inlet 112 of the pump body 110. The outlet portion 802 once coupled with the fluid inlet 112 of the pump body 110 can be rotated relative to the fluid inlet 112 of the pump body 110. The outlet portion 806 and raised surface 802 can be bonded with fluid inlet 112 of the pump body 110 as described above at any position relative to the fluid inlet 112 of the pump body 110. The inlet 804 is configured to receive a plastic tubing. Such a tubing may be placed over the inlet 804 or it may be placed inside the inlet 804 using the push-in type connections described above. As shown in FIG. 5, the outer surface of the inlet fitting 800 may have a barbed profile 808 to securely hold an inlet tubing that is placed over the barbed portion 808. The inlet fitting 800 may also include a check valve 820. The check valve 820 may be an inlet ball check valve, which can function as described above. The inlet fitting 800 is shown to include an external shape that has a straight section followed by a diverging profile. The inlet and outlet geometries are dimensioned to receive a tubing and to couple with the pump body 110, respectively. The remainder of the geometry is dimensioned to provide for an efficient transition from the inlet geometry to the outlet geometry for the inlet fitting.

FIG. 5 also shows a base piece 900. The base piece is an optional part of the kit and as such the base 900 may not be used with certain assembled kit configurations. The base piece 900 is shown to have a rectangular profile in a plan view. The base piece 900 also includes an open portion that is dimensioned to receive and support the pump body 110 and the outlet elbow 200. Surfaces 127 are elevated with respect to surfaces 125 and 225. Surfaces 127 are dimensioned to fit against surfaces 124 such that surface 124 rests against surface 127 when the pump body 110 is placed in the based 900. Likewise, surfaces 125 are lower than surfaces 127. Surfaces 125 are dimensioned to fit against surfaces 214 such that surface 214 rests against surface 125 when the outlet elbow 200 is placed in the based 900. Furthermore, surface 225 is lower than surfaces 127. Surfaces 225 are dimensioned to fit against surfaces 212 such that surface 212 rests against surface 225 when the outlet elbow 200 is placed in the based 900. The base portion 900 also includes one or more mounting bosses 902 that enable the base to be mounted against a mounting bracket, for example, such as bracket 34 shown in FIGS. 1-2. Also shown are recesses 904 that also help with the mounting of the base piece 900 with a bracket. Recesses 904 may also be formed to help for an efficient forming of the mounting boss 902 that is adjacent to the recesses 904. The base piece may also include a rib portion 910. The rib portion 910 is constructed to be a break-away surface so as to enable the base portion to have a smaller length when needed, by an operator breaking portion 910 away from the remainder of the base portion 902. The portion 910 may have a scored area to facilitate its breaking away.

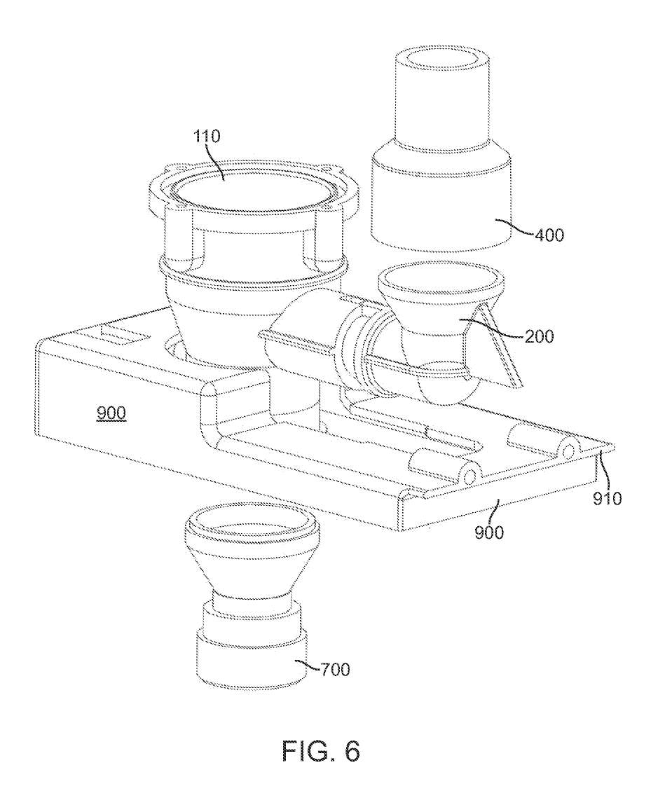

FIG. 6 shows a simplified drawing of a first embodiment of an assembly using the kit of FIG. 5 above. As can be seen in FIG. 6, the assembly includes one inlet fitting 700, the base 900, the pump body 110, the outlet elbow 200 and the outlet fitting 400. The parts can be connected with one-another as is described above. As can be appreciated from a review of FIGS. 5-6, the kit parts all include surfaces that are configured to complementarily connect with other kit parts. In addition, the kits parts can also be modified to fit other dispensing system needs. Such modifications can include the removal of certain portions from a kit part. For example, the lip portion 910 on the base piece 900 can be removed or broken off to suit a particular need.

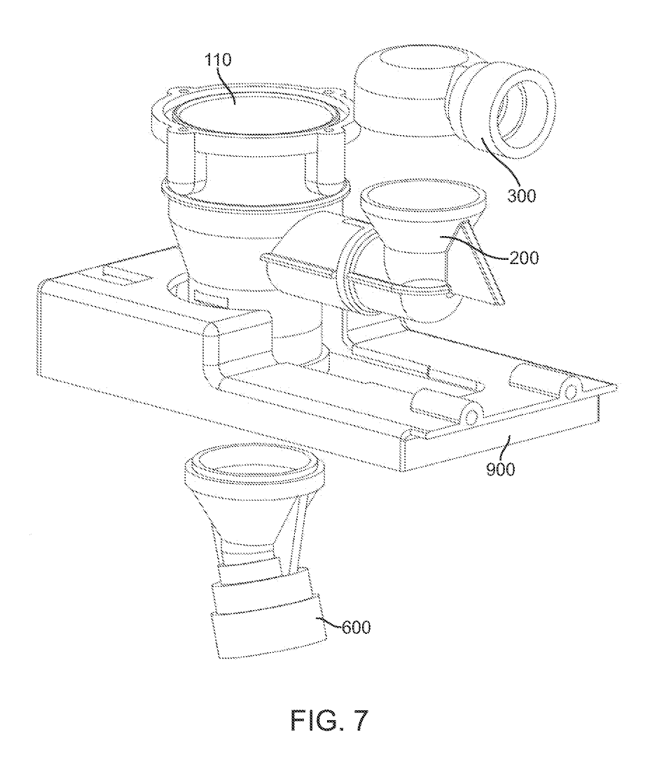

FIG. 7 shows a simplified drawing of another embodiment of an assembly using the kit of FIG. 5 above. As can be seen in FIG. 7, the assembly includes inlet fitting 600, the base 900, the pump body 110, the outlet elbow 200 and the outlet fitting 300. As can be appreciated from a review of FIGS. 5 and 7, the kit parts all include surfaces that are configured to complementarily connect with other kit parts.

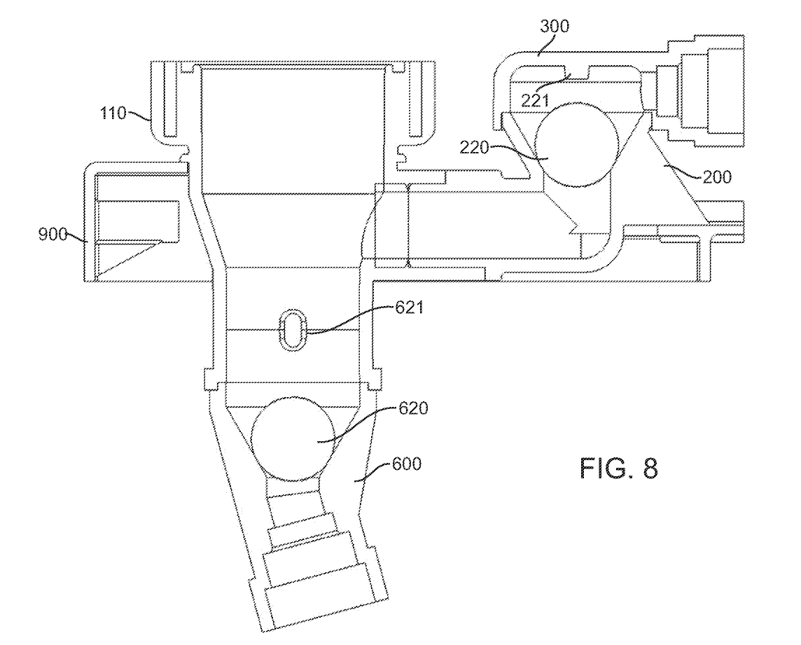

FIG. 8 is a cross-sectional view of the assembled dispensing apparatus component system of FIG. 7. The cross-sectional view of FIG. 8 shows the assembly of FIG. 8 when the parts are fully connected and in place with respect to one-another. FIG. 8 also shows the check valve 620 located in the inlet fitting 600, as well as member 621 which prevents the ball from moving any further when the ball is lifted off its seat during fluid flow. Also shown is the internal flow cross-sectional area for the inlet fitting 600, which is dimensioned to accommodate a push-in type quick connect fitting, such as those described above. FIG. 8 also shows the check valve 220 located in the outlet elbow 200. This figure also shows a member 221 which prevents the ball from moving any further when the ball is lifted off its seat during fluid flow. Also shown is the internal flow cross-sectional area for the outlet fitting 300, which is dimensioned to accommodate a push-in type quick connect fitting, such as those described above.

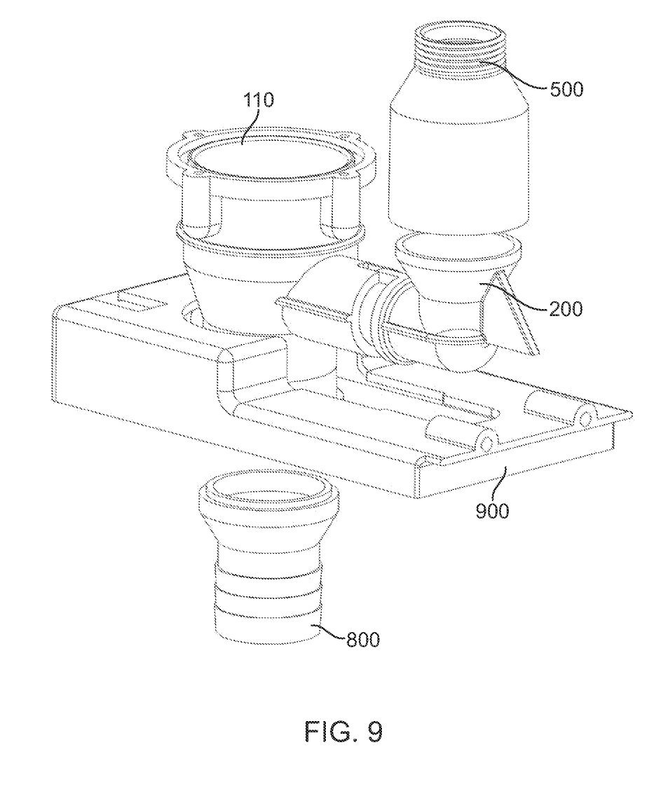

FIG. 9 is a simplified drawing of another alternative embodiment of an assembly using the kit of FIG. 5 above. As can be seen in FIG. 9, the assembly includes the inlet fitting 800, the base 900, the pump body 110, the outlet elbow 200 and the outlet fitting 500. As can be appreciated from a review of FIGS. 5 and 9, the kit parts all include surfaces that are configured to complementarily connect with other kit parts.

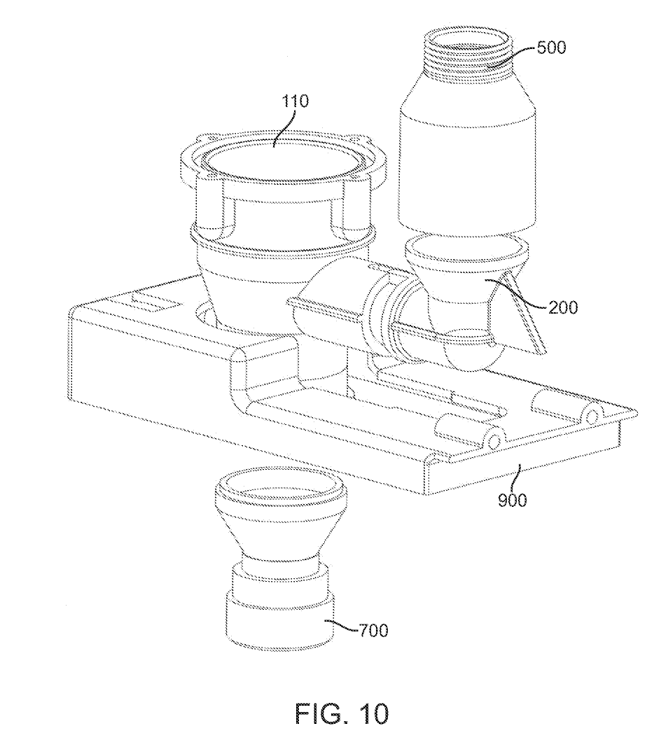

FIG. 10 shows a simplified drawing of another alternative embodiment of an assembly using the kit of FIG. 5 above. As can be seen in FIG. 10, the assembly includes the inlet fitting 700, the base 900, a pump body 110, an outlet elbow 200 and the outlet fitting 500. As can be appreciated from a review of FIGS. 5 and 10, the kit parts all include surfaces that are configured to complementarily connect with other kit parts.

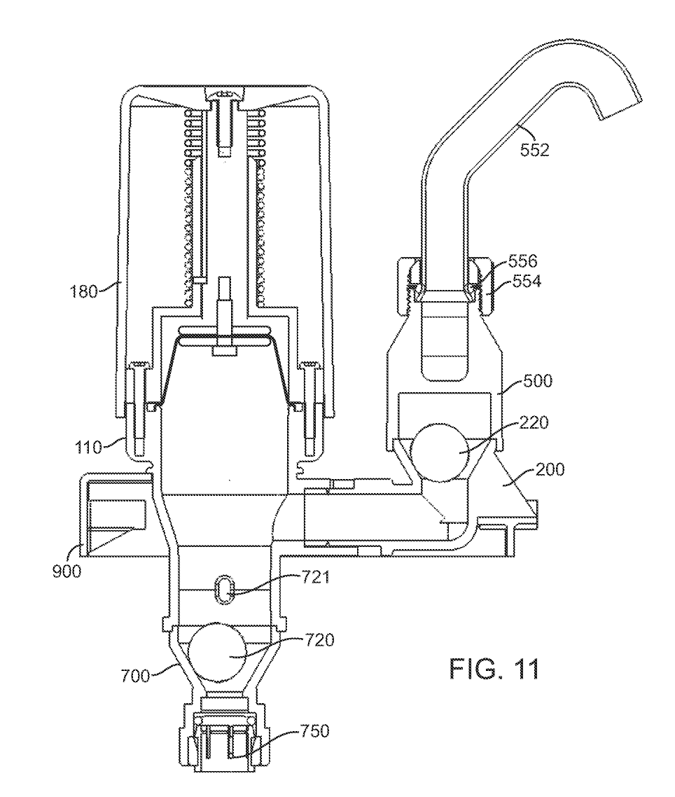

FIG. 11 is a cross-sectional view of the assembled dispensing apparatus using the component system of FIG. 10. The cross-sectional view of FIG. 11 shows the assembly of FIG. 11 when the parts are fully connected and in place with respect to one-another. FIG. 11 also shows the check valve 720 located in the inlet fitting 700, as well as member 721 which prevents the ball from moving any further when the ball is lifted off its seat during fluid flow. Also shown is the internal flow cross-sectional area for the inlet fitting 700, which is dimensioned to accommodate a push-in type quick connect fitting 750, such as those described above. FIG. 11 also shows the check valve 220 located in the outlet elbow 200. Also shown is the internal flow cross-sectional area for the outlet fitting 500, which is dimensioned to receive an outlet spout 552. The outlet spout 552 is held against the seal 556 formed on the inside of the outlet portion of the outlet fitting 500. A nut 554 is used over the screwed fitting 506 to securely hold the outlet spout 552 against the outlet fitting 500. Also shown in FIG. 11 is the active components 180 of a dispenser that are connected above the pump body 110.

As will be understood by those skilled in the art, the present invention may be embodied in other specific forms without departing from the essential characteristics thereof. For example, a given assembly may only contain an inlet fitting, a pump body, an outlet elbow and an outlet fitting without using the base piece. Furthermore, it should be realized that the kit components described above and shown in FIG. 5 can be assembled into a plurality of different assemblies such as the ones described above in FIGS. 6-11. Many other assemblies besides those shown in FIGS. 6-11 may also be formed using the kit parts of FIG. 5. In addition, the chamber may have other shapes, and the plunger may be configured to move in a nonlinear manner. These other embodiments are intended to be included within the scope of the present invention, which is set forth in the following claims.

What is claimed is:

1. A component system kit for assembling a dispensing apparatus, comprising:
at least one inlet fitting, each of said at least one inlet fitting having a fluid inlet and a fluid outlet, the fluid inlet portion of said inlet fitting being configured to receive a conduit for a fluid from a fluid source;
a pump body having a pump fluid inlet and a pump fluid outlet, said pump body fluid inlet and each of said fluid outlets of said inlet fittings being configured to connect said pump fluid inlet with each of said fluid outlets of said one or more inlet fittings;
an outlet elbow having an elbow inlet and an elbow outlet, said outlet elbow inlet being configured to connect with said pump fluid outlet; and
at least one outlet fitting, each of said at least one outlet fitting having a fluid inlet and a fluid outlet, each of said fluid inlets of said outlet fittings being configured to connect with said elbow outlet.

2. The kit of claim 1, further comprising a base configured to support said pump body and said outlet elbow.

3. The kit of claim 2 wherein the pump body includes surface projections configured to rest against a top surface of said base.

4. The kit of claim 2 wherein the outlet elbow includes surface projections configured to rest against a top surface of said base.

5. The kit of claim 1 wherein at least one of said inlet fittings comprises a valve.

6. The kit of claim 5 wherein said valve comprises a check valve.

7. The kit of claim 6 wherein said check valve is a ball check valve.

8. The kit of claim 1 wherein said outlet elbow comprises a valve.

9. The kit of claim 8 wherein said valve comprises a check valve.

10. The kit of claim 9 wherein said check valve is a ball check valve.

11. The kit of claim 1 wherein a raised ring-shaped surface projection extending from the fluid outlet of each of the at least one inlet fittings is dimensioned to fit inside and against an internal surface of the pump fluid inlet.

12. The kit of claim 11 wherein each of the at least one inlet fittings is dimensioned to fit inside and against an internal surface of the pump fluid inlet via a compression fit.

13. The kit of claim 11 wherein one of said inlet fittings is solvent bonded with said pump fluid inlet.

14. The kit of claim 11 wherein one of said inlet fittings is ultrasonically bonded with said pump fluid inlet.

15. The kit of claim 1 wherein the elbow inlet of said outlet elbow is dimensioned to fit inside and against an internal surface of the pump fluid outlet.

16. The kit of claim 15 wherein one of said elbow inlet of said outlet elbow and said pump fluid outlet comprises a key and the other of said elbow inlet of said outlet elbow and said pump fluid outlet comprises a slot shaped to engage the key.

17. The kit of claim 15 wherein said elbow inlet of said outlet elbow is dimensioned to fit inside and against an internal surface of the pump fluid outlet via a compression fit.

18. The kit of claim 15 wherein said elbow inlet of said outlet elbow is solvent bonded with said pump fluid outlet.

19. The kit of claim 15 wherein said elbow inlet of said outlet elbow is ultrasonically bonded with said pump fluid outlet

20. The kit of claim 1 wherein the fluid inlet of each of the at least one outlet fittings is dimensioned to fit over and against an external surface of the outlet elbow outlet.

21. The kit of claim 20 wherein each of said fluid inlets of each of the at least one outlet fittings is dimensioned to fit over and against an external surface of the outlet elbow outlet via a compression fit.

22. The kit of claim 20 wherein one of said outlet fittings is solvent bonded with said outlet elbow outlet.

23. The kit of claim 20 wherein one of said outlet fittings is ultrasonically bonded with said outlet elbow outlet.

24. The kit of claim 1 wherein at least one of said inlet fitting fluid inlets comprises a quick connect fitting so as to receive a fluid conduit therein.

25. The kit of claim 1 wherein at least one of said outlet fitting fluid outlets comprises a quick connect fitting so as to receive a fluid conduit therein.

26. A method of forming a portion of a dispensing apparatus, comprising:
providing a kit having
at least one inlet fitting, each of said at least one inlet fitting having a fluid inlet and a fluid outlet, the fluid inlet portion of said inlet fitting being configured to receive a conduit for a fluid from a fluid source;
a pump body having a pump fluid inlet and a pump body fluid outlet, said pump fluid inlet and each of said fluid outlets of said inlet fittings being configured to connect said pump fluid inlet with each of said fluid outlets of said one or more inlet fittings;
an outlet elbow having an elbow inlet and an elbow outlet, said outlet elbow inlet being configured to connect with said pump fluid outlet; and
at least one outlet fitting, each of said at least one outlet fitting having a fluid inlet and a fluid outlet, each of said fluid inlets of said outlet fittings being configured to connect with said elbow outlet;
connecting the fluid outlet of one of the inlet fittings with the fluid inlet of the pump;
connecting the fluid inlet of the outlet elbow with the fluid outlet of the pump; and
connecting the fluid inlet of one of the outlet fittings with the elbow outlet.

27. The method of claim 26 wherein said connecting comprises one of a solvent bonding and ultrasonic bonding.
